(19) United States
(12) Patent Application Publication
(10) Pub. No.: US 2010/0050243 A1
(43) Pub. Date: Feb. 25, 2010

(54) METHOD AND SYSTEM FOR TRUSTED CLIENT BOOTSTRAPPING

(75) Inventor: Dick C. Hardt, Vancouver (CA)

Correspondence Address: PERLEY-ROBERTSON, HILL & MCDOUGALL LLP, 1400-340 Albert Street, OTTAWA, ON, K1R 0A5, CA

(73) Assignee: SXIP IDENTIFY CORP., Vancouver, BC (CA)

(21) Appl. No.: 12/517,604

(22) PCT Filed: Dec. 4, 2007
(86) PCT No.: PCT/CA07/02157

§ 371 Date: Oct. 16, 2009

(30) Foreign Application Priority Data
Dec. 4, 2006 (US) 60868491

(51) Int. Cl. H04L 9/32

(52) U.S. Cl. 726/6; 726/7; 726/10

(57) ABSTRACT

Bootstrapping a trusted cryptographic certificate or other credentials into a client web browser application can be used to provide protection against “phishing” and “man-in-the-middle” attacks made over a computer network. Verification credentials are provided to users who connect directly to an authentication server and provide sufficient authentication information. The authentication server can rely upon the use of private URLs associated with each user as part of the verification process and can reject users who connect by clicking on a hyperlink directed to the authentication server.

### CROSS REFERENCE TO RELATED APPLICATIONS

This application claims the benefit of U.S. Provisional Application No. 60/868,491 filed Dec. 4, 2006, which is incorporated herein by reference.

### FIELD OF THE INVENTION

The present invention relates generally to establishing a trusted relationship between two nodes in a network. More particularly, it relates to a method and system for establishing a relationship between two network nodes in such a way that one node is able to be certain of the authenticity of the other.

### BACKGROUND OF THE INVENTION

In many online transactions, certain services are performed by different hosts in the network. One example of this, which is very common in certain web-based applications, is that authentication is delegated to hosts other than the application host. This allows authentication services to be run by a secure system that specializes in authentication, freeing the application host from the necessity of being updated for security fixes if needed. To allow this, the application host redirects a user's web client (e.g. a standard web browser) to the authentication server, authentication is performed and the client is redirected back to the application host. FIG. 1 outlines one such transaction. The user controls browser 100, and directs the browser to Application Server 102, which relies upon Authentication Server 104 for its authentication services. Application Server 102 and Authentication Server 104 need not be related to each other or be administered by the same entity, they can, however, be members in an identity management network. The user requests a service from Application Sever 102 over connection 106. The request for service 106 causes Application Server 102 to redirect the connection to the Authentication server 104 using authentication redirection 108a and 108b. Authentication redirection 108 (a combination of 108a and 108b) can contain information such as a nonce that should be returned to allow Application Server 102 to determine which session has been authenticated when the user is returned. Other information can also be included in the authentication redirection 108. Authentication Server 104 performs authentication of the user of browser 100, here shown as authentication challenge 110 and authentication response 112. When Authentication Server 104 has authenticated the user of browser 100, the authentication response is sent to the Application Server 102 by redirecting the user browser 100 using authentication response 114 (a combination of 114a and 114b). The Application Server 102 can then provide user browser 100 with the requested service over connection 116. Upon authentication, the user is typically provided a token from the authentication server 104 to provide to the application server 102. The token provides a secure indication that the authentication has been successfully completed.

These communications are secure if secure channels are created, and if all the parties in the communication are trustworthy. The application provider that controls Application Server 102 is not typically provided with the data that the user used to authenticate. In a single-sign on system that allows a user to use an account with an authentication server to sign in to a plurality of services, this provides the user with security and an assurance that a particular application provider will not be able to use the user's credentials to create accounts at other application providers, or use the information to perform another type of fraud. However, a rogue application provider may seek to obtain the authentication credentials of users through the use of a man-in-the-middle attack. In such an attack, the security of the communication between the user browser 100 and the authentication server 104 is compromised by inserting a transparent node into the communications channel between the browser 100 and the authentication server 104.

To do this, the application provider can fraudulently redirect the user to a server that then acts as a proxy between the browser 100 and authentication server 104. If the proxy creates a secure connection between itself and the browser 100, and then a second secure connection between itself and the authentication server 104, it can provide the appearance of a seamless secure connection, while still being able to covertly intercept the user's authentication credentials (e.g. username and password). When the proxy receives pages from the Authentication Server 104, it can relay the pages to the user browser 100 without the user easily being able to detect the interception, and then receive the user response and provide it to the Authentication Server 104 without the Authentication Server 104 being able to detect the fraud. This permits the proxy to obtain all information that is transmitted between the user and the authentication provider. The user's authentication credentials, such as a name and password pair, can then be harvested as they are passed from the user's web browser 100 to the authentication server 104.

However, if the user's browser 100 has been provided a credential that can only be read by the Authentication Server 104, and this credential is checked by the Authentication Server 104 prior to the start of the authentication operation, this man in the middle attack can be foiled by ensuring that there is an unintercepted connection between the browser 100 and the authentication server 104. Ideally these credentials are issued either by the authentication server 104 itself or by a trusted third party. Examples of such credentials include a cryptographic certificate such as those used in SSL communications, or a “cookie” data generated by the server and stored on the client.

Cookies stored by a user client are only available to servers in the domain that issues the cookie. This prevents cookie-based credentials from being accessed by phishing or proxy sites unless they have successfully spoofed the DNS system. Successful spoofing of the DNS system is a sufficiently severe breech of security that it is often regarded as equivalent to a compromised client browser. Cryptographic certificates, such as X.509 certificate credentials, are used within a cryptographically secure SSL/TLS connection, so they provide the same functionality, and are resistant to DNS attacks.

Upon receiving proof that the user has connected with a direct connection, the authentication server 104 can provide a personalized page layout containing a user selected indication that the authentication server has recognized that the user has safely connected. If the user is presented a different page, it is clear that there is a problem with the connection to the server, and the user can then withhold the authentication credentials to avoid them being intercepted. Often the personalized page contains a layout or graphic selected or provided by the client. This can be thought of as the server revealing, over a secure connection, a shared secret to the user to confirm its identity.

In standard “phishing” attacks, the client is directed to a facsimile of the authentic server. It is difficult for a fraudulent server to properly personalize the page. The absence of the personalized page is indicative to the user that there is a problem with the connection.

Thus, when the authentication server 104 provides the client browser 100 with a credential, it is possible for the user to determine that it is the authentication provider that has been reached. There remains, however, the fundamental problem that this requires that the user obtain the credentials from a server using a secure transmission method.

It is, therefore, desirable to provide an identity management solution that allows a user to provide persona based identity information to form using accurate mappings.

### SUMMARY OF THE INVENTION

One object of the present invention to obviate or mitigate at least one disadvantage of authentication systems.

In a first aspect of the present invention, there is provided a method of issuing verification credentials to a user client. The method includes the steps of receiving, at a specified resource, a request for verification credentials from a user; confirming that the user is directly connected to the specified resource; authenticating the user against known authentication information associated with the user; and generating and transmitting verification credentials to the user upon successful authentication of the user.

In embodiments of the first aspect, the specified resource is a universal resource locator and the request is a hypertext transfer protocol based request. In further embodiments, the step of confirming that the user is directly connected includes examining the hypertext transfer protocol referrer header parameter and the verification credential includes a cookie.

In other embodiments, the step of rejecting the connection to the user prior to the step of authentication if the header parameter indicates that the user was referred to the specified resource by another resource, and the step of confirming further includes determining that the user has not been referred by another resource.

In further embodiments of the first aspect of the present invention, the step of authenticating includes validating a username and password pairing against known authentication information, verifying a shared secret against known authentication information, or verifying biometric information again known authentication information. The verification credential can be a cryptographic certificate such as an X.509 certificate.

In a second aspect of the present invention, there is provided an authentication server for issuing verification credentials to a user. The authentication server comprises a user database, an authentication engine and a credential generator. The user database stores user authentication information. The authentication engine accepts connection requests from users and authenticates the users against authentication information stored in the user database upon determining that the user is directly connected to the authentication server. The verification credential generator issues verification credentials to users upon authentication by the authentication engine.

In embodiments of the second aspect of the present invention, the authentication server includes an enrollment engine for generating user accounts in the user database and a resource generator for generating a resource mapped to the authentication engine specific to a user account. The authentication engine can accept connection request from the user at the generated resource associated with the user, the generated resource being a URL mapped to the authentication engine and associated with a specific user account. The authentication engine can include means to authenticate the user if the user has directly connected over the universal resource locator associated with the user, and has provided the authentication information stored in the user database.

Other aspects and features of the present invention will become apparent to those ordinarily skilled in the art upon review of the following description of specific embodiments of the invention.

### BRIEF DESCRIPTION OF THE DRAWINGS

Embodiments of the present invention will now be described, by way of example only, with reference to the attached Figures, wherein:

FIG. 1 illustrates a conventional user authentication process;

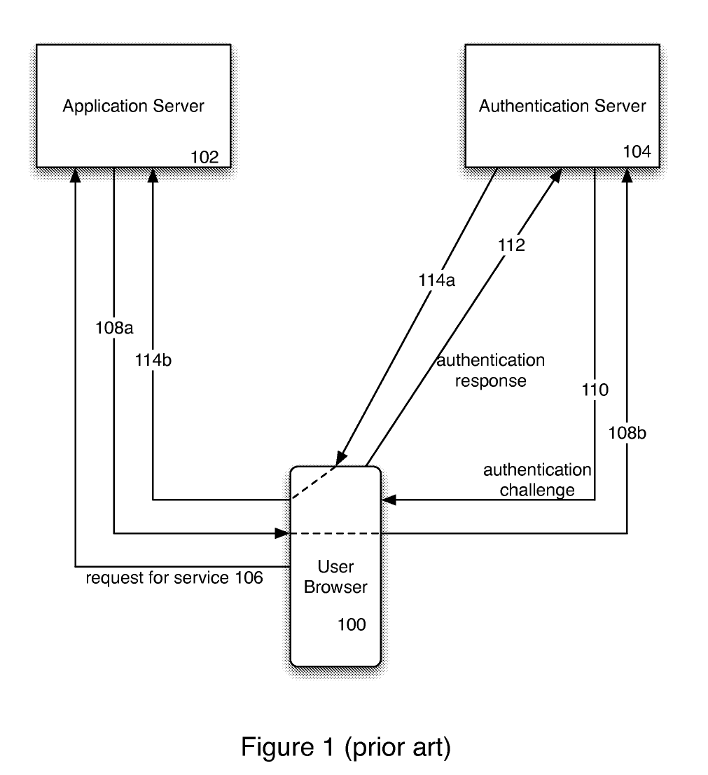

FIG. 2 is a flowchart illustrating a method of the present invention; and

FIG. 3 illustrates an exemplary embodiment of a system of the present invention.

### DETAILED DESCRIPTION

Generally, the present invention provides a method and system for bootstrapping a trusted communication between a user client and an authentication provider. A client bootstrap method is designed to establish a trusted connection between an authentic server and client. This connection allows transfers of credentials from the server to client.

Reference is made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

When a user makes use of an authentication server, the user must create an account with the authentication server, which is then used in the authentication process. In order for the authentication server to provide the user browser with a verification credential that is used to confirm that the connection between the server and browser is not being intercepted, it is essential that the authentication server be assured that the account creation process is not subject to a man-in-the-middle attack. If the account setup session is compromised, then both the user authentication details and the verification credential can be intercepted. The present invention seeks to provide a mechanism to reduce the likelihood of a man-in-the-middle attack by bootstrapping the client with the verification credentials used by the authentication server to ensure a secure connection.

Users establish relationships with authentication providers online, typically by initiating a communication session that starts the process of building a user account. It is known that many users connect to an authentication provider by clicking on a link at an application provider or other site that directs the user to the authentication provider. By relying upon a link, the user is subject to the possibility of a man-in-the-middle attack. Often, to validate the account, an out of band communication is sent to the user. One such out of band communication is an email message sent to an email address provided by the user. This allows the authentication server to confirm that the user has provided a legitimate email address, and provides the secondary benefit that if the user clicks on a hyperlink in the provided email message, that a direct connection is forged. The authentication credentials, often in the form of shared secrets, can be exchanged after the email verification. This provides a degree of certainty to the authentication server that the user has directly connected, reducing the chance for a man-in-the-middle attack.

This process allows the user to obtain the verification credential on the computer which was used to perform the registration process. However, it does not provide the user with the ability to obtain the verification credentials on other computers, which is essential in an environment where many users connect from a plurality of different computers.

The mechanism outlined below can be used in a variety of fashions, including as a mechanism to obviate the need for the out of band connection through email, which is only useful if the user is able to connect to their email account from the computer that they are performing the registration from, which is not always the case.

It should be noted in advance, that the mechanisms outlined below may not be sufficient to overcome a compromised client. If the security of the client computer has already been compromised before the registration process, then the security of the transaction may not be able to be maintained, as the compromise in the client could be something such as a key logger application that surreptitiously records the user authentication credentials, and thus overcomes any security that is provided in the transactional setup.

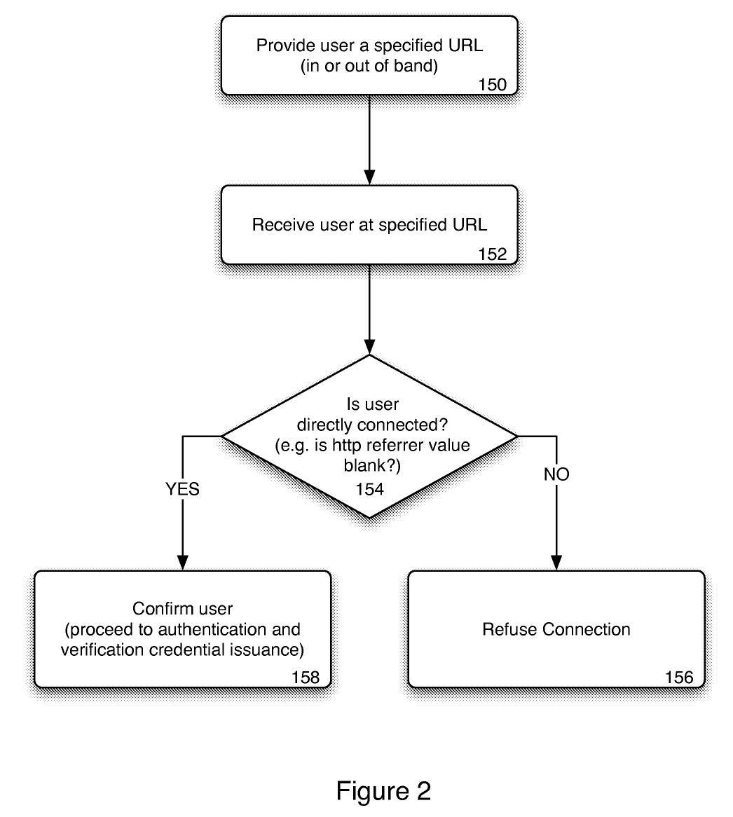

FIG. 2 outlines a flowchart illustrating a method of the present invention that can be used to ensure a secure connection. This method can be used as a portion of a registration process, or can be used to bootstrap further clients for the user. In step 150 the user is provided a universal resource locator (URL) that the client can be directed to. Preferably this URL contains information that allows the authentication server to identify the user based on the URL. The URL can either be provided to the user in an out of band connection (e.g. an email message), or can be displayed to the user on a generated webpage. To ensure that the connection to the user is not being run through a transparent proxy, the user is asked to connect to the URL by typing in the URL instead of clicking on the URL. This forces the browser to create a connection to the URL as specified. If a proxy has intercepted the message, a hyperlink may direct the user to the URL through the proxy, but will not be able to monitor a connection that is created by the user typing the URL in directly. The only proxy that could intercept this connection is one that has been setup by the user in a network setup configuration, and the system must trust that such a proxy is approved by the user (in fact, such a proxy will be transparent to all involved).

Upon the user manually entering the URL, the user is received at the specified URL by the authentication server at step 152. In step 154 the authentication server determines if the user has connected directly or not. This can be done in a number of ways. In one exemplary embodiment, the authentication server checks the HTTP referrer header parameter to determine where the user was referred to the URL from. If the parameter indicates that the user was not referred from another site it can be taken as confirmation that the user manually entered the URL, and thus is not connecting over an unauthorized proxy. If there is a referring site, then the connection can be deemed to be insufficiently secure. If the decision in step 154 is that there is not a direct connection, then the authentication server can refuse the connection in step 156. Optionally, the authentication server can request that the user attempt to re-enter the URL manually to complete the process. If in step 154 it is determined that the user has connected directly, the authentication server can confirm the user in step 158 and issue the verification credentials.

During the registration process, the authentication server can provide the user with a personalized resource to connect to, from which the credentials can be obtained. This personalized resource can be provided with a user friendly URL so that the user can easily enter the URL from any system without resorting to having to search for it in an email message.

In one embodiment, the user is provided with a personalized URL on the authentication host. In web browsers, the primary way to securely navigate to a known URL is to type the URL directly into the address field in the navigation bar. The personalization of the URL provides the user with a simple mechanism for forging this secure connection. Ther personalization of the URL can be done in any number of ways, including providing a URL that includes the username associated with the user. If the authentication server is located at https://authentication.example.com the personalized address could be https://username.authentication.example.com. Alternatively, the URL could be a customized directory such as https://authentication.example.com/username. Other variations will be understood by those skilled in the art, and should be considered as being within the scope of the present invention.

The user, from any computer system can then obtain the required verification credentials by providing the assigned personal URL to the browser client. To mitigate the risk of a man-in-the-middle attack, this URL is preferably never linked to as a hyper-link and is entered manually in the browser's address bar. For added security a cryptographically secure protocol such as SSL/TLS is used.

By providing an address that itself contains a portion of a shared secret (e.g. the username), the authentication server makes spoofing more difficult.

When the server is contacted at this URL it can display the user's personalized login page and initiates a conventional authentication procedure using a user name and password. It can also check the referrer HTTP header parameter to ensure that its address has been entered manually. If the address has not been entered manually, the server can refuse the connection to prevent the possibility of a future man-in-the-middle attack.

Once the user has been authenticated in this manner (a combination of manually entering the URL and then successfully completing an authentication challenge such as the provision of username and password pairing), the server can send the client credentials for future authentication from that client. Credentials may be as simple as “cookie” data, or a client side X.509 certificate signed by the server's certificate key. The client certificate is imported into the client web browser. In systems that value security over simplicity, cryptographic certificates, such as X.509 certificates, are preferred over cookies.

When the client next contacts the server, it can supply the verification credentials established in the process outlined above. The server now knows whether or not it is talking directly to a valid client. If the verification credentials provided by the user do not match the credential expected, an error message can be displayed to the user. Otherwise the authentication server can proceed with further authentication steps and displays a personalized login page to the user.

In a variation of the method, credentials for multiple user accounts may also be used. A cookie, or certificate, for each user account is stored, and the server prompts the user to select an account before presenting the personalized page for that account. Similarly, if an authentication server is used for all the users in a particular entity, such as users associated with a company, the entity can be provided a single personalized URL, which all users can connect to.

In one scenario, employees of a corporation can be provided a corporation specific personalized URL. The accounts for these users at an authentication server can be created either using a standard enrollment process, or they can be created using another mechanism including having an administrator create the authentication account and assign the authentication challenge information to the users. In the following example the authentication challenge information will be referred to in the context of a username and password, although those skilled in the art will appreciate that other challenges including biometric information, synchronized token generators and other resources can be used as authentication challenge information without departing from the scope of the present invention. An employee seeking remote access to corporate resources from a computer types the URL specific to the corporation. When the authentication server receives the user (as in step 152), any of the valid authentication challenge data sets can be provided. Thus each user in the corporation will connect to the same URL. The authentication server will then determine whether the connection is direct and if so, will request a valid username and password. When the employee provides one of the username and password pairs that is registered with the authentication server, the authentication server provides the verification credential that can later be used to ensure that the user has a direct connection to the authentication server when a corporate resource redirects the user to the authentication server for authentication.

By providing a URL that is easy to remember, users are provided a resource that is easy to access, and reduces the trouble that users have with entering long URLs. Furthermore, the users is provided a greater degree of confidence that the connection that they have created to the authentication server is correct than if they had been required to type in a long URL that includes a session specific nonce.

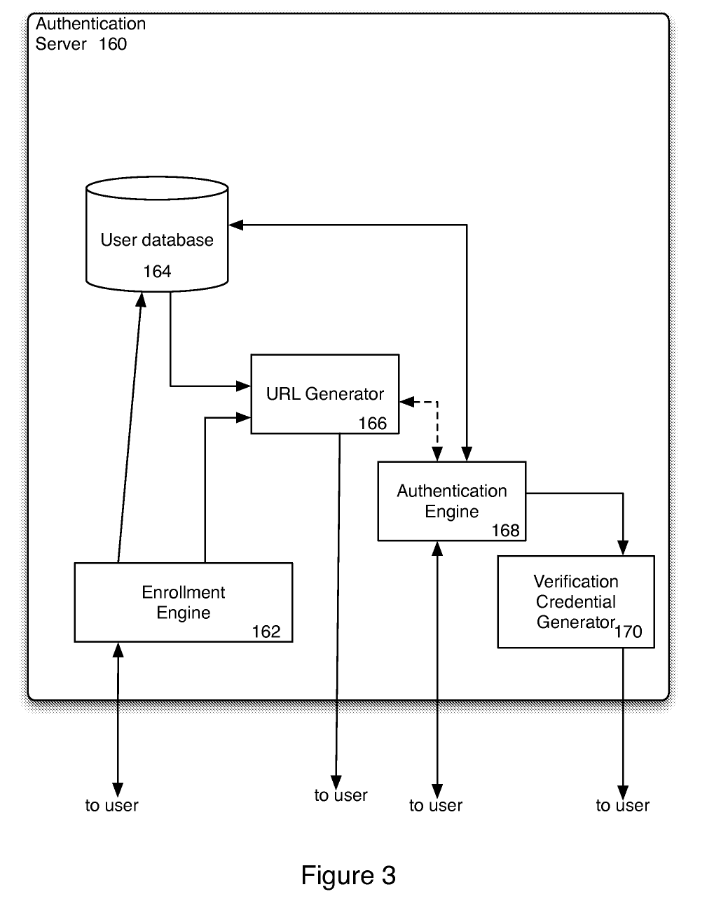

An authentication server of the present invention is illustrated in exemplary form in FIG. 3. Authentication Server 160 interacts with the user client to authenticate the user and issue the verification credential that can later be used to verify the security of the connection to the user. Authentication Server 160 includes enrollment engine 162 which is used to enroll users by generating accounts that are stored in user database 164. Database 164 contains authentication information, such as username and password pairs, other shared secrets, or other information that can be used to authenticate a user such as biometric information. Enrollment engine 162 receives information about the user, either from the user or from an administrator, stores the user authentication information in the User database 164 and the instructs the URL generator 166 to provide a customized URL that can be used by the user to obtain verification credentials. The customized URL can be unique to a user, or can be unique to a class of users.

After user accounts have been created and the customized URLs have been generated, the authentication server 160 can receive connection requests at the authentication engine 168. Prior to beginning the authentication of a user, Authentication Engine 168 confirms that the user has directly connected to the Authentication server 160. This may be performed in any of a number of ways, including the use of the referrer header information provided with an HTTP connection request. If the user has connected directly, and can provide authentication details that can be verified against the user database 164, the authentication engine 168 invokes the verification credential generator 170 which issues the verification credentials to the user client. These verification credentials can include cookies or cryptographic certificates that can be used to ensure that further connections between the authentication server and the user client are secure.

Where URL generator 166 generates a URL specific to a particular user, or class of users, the generated URL can be stored in user database 164 and associated with the user. When authentication engine 168 receives a request for authentication at a particular URL, it can ensure that the URL that was requested matches the URL associated with the provided authentication information. This provides a further layer of security to the user.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method of issuing verification credentials to a user client comprising:
receiving, at a specified resource, a request for verification credentials from a user;
confirming that the user is directly connected to the specified resource;
authenticating the user against known authentication information associated with the user; and
generating and transmitting verification credentials to the user upon successful authentication of the user.

2. The method of claim 1 wherein the specified resource is a universal resource locator and the request is a hypertext transfer protocol based request.

3. The method of claim 2 wherein the step of confirming that the user is directly connected includes examining the hypertext transfer protocol referrer header parameter.

4. The method of claim 3 further including the step of rejecting the connection to the user prior to the step of authentication if the header parameter indicates that the user was referred to the specified resource by another resource.

5. The method of claim 3 wherein the step of confirming further includes determining that the user has not been referred by another resource.

6. The method of claim 1 wherein the step of authenticating includes validating a username and password pairing against known authentication information.

7. The method of claim 1 wherein the step of authenticating includes verifying a shared secret against known authentication information.

8. The method of claim 1 wherein the step of authenticating includes verifying biometric information again known authentication information.

9. The method of claim 1 wherein the verification credential includes a cryptographic certificate.

10. The method of claim 9 wherein the cryptographic certificate is an X.509 certificate.

11. The method of claim 2 wherein the verification credential includes a cookie.

12. An authentication server for issuing verification credentials to a user comprising:
a user database for storing user authentication information;
an authentication engine for accepting a connection request from a user and for authenticating the user against authentication information stored in the user database upon determining that the user is directly connected to the authentication server; and
a verification credential generator for issuing verification credentials to the user upon the user being authenticated by the authentication engine.

13. The authentication server of claim 12 further including:
an enrollment engine for generating user accounts in the user database; and
a resource generator for generating a resource mapped to the authentication engine specific to a user account.

14. The authentication server of claim 13 wherein the authentication engine accepts connection request from the user at the generated resource associated with the user.

15. The authentication server of claim 13 wherein the generated resource is a universal resource locator mapped to the authentication engine and associated with a specific user account.

16. The authentication server of claim 15 wherein the authentication engine includes means to authenticate the user if the user has directly connected over the universal resource locator associated with the user, and has provided the authentication information stored in the user database.
